(19) United States
(12) Patent Application Publication
(10) Pub. No.: US 2023/0160360 A1
(43) Pub. Date: May 25, 2023

(54) LEAKAGE DIAGNOSTIC DEVICE, AND VEHICLE

(71) Applicant: TOYOTA JIDOSHA KABUSHIKI KAISHA, Toyota-shi (JP)

(72) Inventors: Hideki MIYAHARA, Miyoshi-shi (JP); Takumi ANZAWA, Toyota-shi (JP); Keita FUKUI, Fujinomiya-shi (JP)

(73) Assignee: TOYOTA JIDOSHA KABUSHIKI KAISHA, Toyota-shi (JP)

(21) Appl. No.: 17/929,800

(22) Filed: Sep. 6, 2022

(30) Foreign Application Priority Data
Nov. 25, 2021 (JP) 2021-191331

(51) Int. Cl. F02M 25/08

(52) U.S. Cl. CPC F02M 25/0809; F02M 25/0836

(57) ABSTRACT

A controller is configured to execute an emission process of, on condition that the number of times a leakage diagnosis of a fuel tank is performed in a stop period from when an internal combustion engine stops to when the engine restarts is less than a predetermined allowable number of times, emitting gas from the fuel tank via a canister by opening a shut-off valve, execute a diagnosis process of performing the leakage diagnosis based on a change in index value, caused by the emission process, the index value indicating a pressure in the fuel tank, and execute a subtraction process of, when fuel has been fed to the fuel tank in a state where the shut-off valve is open in the stop period of the internal combustion engine, reducing the allowable number of times in the stop period in which fuel has been fed to the fuel tank.

### CROSS-REFERENCE TO RELATED APPLICATION

This application claims priority to Japanese Patent Application No. 2021- 191331 filed on Nov. 25, 2021, incorporated herein by reference in its entirety.

### BACKGROUND

### 1. Technical Field

The disclosure relates to a leakage diagnostic device and a vehicle.

### 2. Description of Related Art

A fuel supply system described in Japanese Unexamined Patent Application Publication No. 2013-087661 (JP 2013-087661 A) includes a fuel tank, a vapor passage, a canister, an outside air passage, and a shut-off valve. The fuel tank stores fuel. The canister is connected to the fuel tank via the vapor passage. The canister is able to adsorb evaporated fuel generated in the fuel tank. The outside air passage is connected to the canister. The shut-off valve is located in the middle of the vapor passage. The shut-off valve opens and closes the flow channel of the vapor passage.

The leakage diagnostic device described in JP 2013-087661 A performs a leakage diagnosis of the fuel tank during a stop of an internal combustion engine. Specifically, the leakage diagnostic device described in JP 2013-087661 A emits gas from the fuel tank by opening the shut-off valve. Then, the leakage diagnostic device described in JP 2013-087661 A performs a leakage diagnosis of the fuel tank based on a change in index value that indicates a pressure in the fuel tank. The leakage diagnostic device described in JP 2013-087661 A limits the number of times a leakage diagnosis is performed to a predetermined allowable number of times in a period from when the internal combustion engine stops to when the internal combustion engine restarts. With this configuration, emission of an excessive amount of evaporated fuel is suppressed as a result of leakage diagnosis.

### SUMMARY

In the fuel supply system described in JP 2013-087661 A, even when a leakage diagnosis is not performed, gas containing evaporated fuel can move from the fuel tank to the canister via the vapor passage during a stop of the internal combustion engine. When gas containing evaporated fuel moves in this way, the amount of evaporated fuel adsorbed by the canister increases. As a result, in the fuel supply system described in JP 2013-087661 A, even when the number of times a leakage diagnosis is performed during a stop of the internal combustion engine is less than the allowable number of times, there is a possibility that evaporated fuel is not able to be adsorbed by the canister any more. If a leakage diagnosis is performed in a state where evaporated fuel is not able to be adsorbed by the canister, gas containing evaporated fuel in the fuel tank is undesirably emitted to the outside.

An aspect of the disclosure relates to a leakage diagnostic device. The leakage diagnostic device includes circuitry configured to perform a diagnosis of a fuel supply system. The fuel supply system includes a fuel tank configured to store fuel, a vapor passage connected to the fuel tank, a canister connected to the vapor passage and configured to be able to adsorb evaporated fuel generated in the fuel tank, an outside air passage connected to the canister, and a shut-off valve configured to open and close a flow channel of the vapor passage. The circuitry is configured to execute an emission process of, on condition that the number of times a leakage diagnosis of the fuel tank is performed in a stop period from when an internal combustion engine stops to when the internal combustion engine restarts is less than a predetermined allowable number of times, emitting gas from the fuel tank via the canister by opening the shut-off valve, a diagnosis process of performing the leakage diagnosis based on a change in index value, caused by the emission process, the index value indicating a pressure in the fuel tank, and a subtraction process of, when fuel has been fed to the fuel tank in a state where the shut-off valve is open in the stop period of the internal combustion engine, reducing the allowable number of times in the stop period in which fuel has been fed to the fuel tank.

With the above configuration, when gas containing evaporated fuel is pushed out from the fuel tank as a result of feeding fuel to the fuel tank and the amount of evaporated fuel adsorbed by the canister increases, the allowable number of times is reduced. Thus, after feeding fuel, the number of times a leakage diagnosis is performed is further strictly limited. This reduces a situation in which a leakage diagnosis is performed regardless of the fact that the amount of evaporated fuel that is able to be adsorbed by the canister is small and, as a result, gas containing evaporated fuel is emitted to the outside.

In the above configuration, in the subtraction process, the circuitry may be configured to increase an amount of subtraction of the allowable number of times when a large amount of fuel is fed to the fuel tank in the stop period as compared to the amount of subtraction of the allowable number of times when a small amount of fuel is fed to the fuel tank in the stop period.

With the above configuration, when there is a large amount of fuel fed to the fuel tank, that is, when the amount of evaporated fuel that is pushed out from the fuel tank is large, the allowable number of times is reduced by a larger amount. Therefore, the amount of evaporated fuel adsorbed by the canister is able to be further accurately reflected in the allowable number of times.

Another aspect of the disclosure relates to a vehicle. The vehicle includes an internal combustion engine serving as a driving source of the vehicle, a motor generator serving as a driving source of the vehicle, a battery configured to supply electric power to the motor generator, a fuel supply system configured to supply fuel to the internal combustion engine, and a leakage diagnostic device configured to perform a diagnosis of the fuel supply system. The fuel supply system includes a fuel tank configured to store fuel, a vapor passage connected to the fuel tank, a canister connected to the vapor passage and configured to be able to adsorb evaporated fuel generated in the fuel tank, an outside air passage connected to the canister, and a shut-off valve configured to open and close a flow channel of the vapor passage. The leakage diagnostic device is configured to execute an emission process of, on condition that the number of times a leakage diagnosis of the fuel tank is performed in a stop period from when the internal combustion engine stops to when the internal combustion engine restarts is less than a predetermined allowable number of times, emitting gas from the fuel tank via the canister by opening the shut-off valve, a diagnosis process of performing the leakage diagnosis based on a change in index value, caused by the emission process, the index value indicating a pressure in the fuel tank, and a subtraction process of, when fuel has been fed to the fuel tank in a state where the shut-off valve is open in the stop period of the internal combustion engine, reducing the allowable number of times in the stop period in which fuel has been fed to the fuel tank.

With the above vehicle, the vehicle can be driven by using the driving force of only the motor generator, so there are many opportunities that the internal combustion engine stops. With an increase in opportunity to stop the internal combustion engine, an opportunity to perform a leakage diagnosis increases. In addition, an opportunity to feed fuel in a state where the internal combustion engine is stopped and then cause the vehicle to run and stop in a state where the internal combustion engine is stopped also increases. In this way, it is suitable to apply the above-described leakage diagnostic device to a vehicle in which there are many opportunities to perform a leakage diagnosis and there are many opportunities to feed fuel during a stop of the internal combustion engine.

In the above configuration, the battery may be chargeable from an external power supply provided outside the vehicle. The above vehicle, that is, a so-called plug-in hybrid electric vehicle, generally includes a large-capacity battery, so one-time stop period of the internal combustion engine tends to be long. As a result, the number of times a leakage diagnosis is performed in a one stop period of the internal combustion engine tends to increase. Therefore, it is suitable to apply the above-described leakage diagnostic device to the above vehicle.

Further another aspect of the disclosure relates to a leakage diagnostic device. The leakage diagnostic device includes circuitry configured to perform a diagnosis of a fuel supply system. The fuel supply system includes a fuel tank configured to store fuel, a vapor passage connected to the fuel tank, a canister connected to the vapor passage and configured to be able to adsorb evaporated fuel generated in the fuel tank, an outside air passage connected to the canister, and a shut-off valve configured to open and close a flow channel of the vapor passage. The circuitry is configured to execute an emission process of, on condition that the number of times a leakage diagnosis of the fuel tank is performed in a stop period from when an internal combustion engine stops to when the internal combustion engine restarts is less than a predetermined allowable number of times, emitting gas from the fuel tank via the canister by opening the shut-off valve, a diagnosis process of performing the leakage diagnosis based on a change in index value, caused by the emission process, the index value indicating a pressure in the fuel tank, and a subtraction process of, when the pressure in the fuel tank is higher than an atmospheric pressure and the shut-off valve is opened in the stop period of the internal combustion engine, reducing the allowable number of times in the stop period while the shut-off valve is open.

With the above configuration, when gas containing evaporated fuel is pushed out from the fuel tank due to a high pressure in the fuel tank and the amount of evaporated fuel adsorbed by the canister increases, the allowable number of times is reduced. Thus, the number of times a leakage diagnosis is performed is further strictly limited. This reduces a situation in which a leakage diagnosis is performed regardless of the fact that the amount of evaporated fuel that is able to be adsorbed by the canister is small and, as a result, gas containing evaporated fuel is emitted to the outside.

In the above configuration, in the subtraction process, the circuitry may be configured to increase an amount of subtraction of the allowable number of times when there is a large difference between the pressure in the fuel tank and the atmospheric pressure in the stop period as compared to an amount of subtraction of the allowable number of times when there is a small difference between the pressure in the fuel tank and the atmospheric pressure in the stop period.

With the above configuration, when there is a large difference between a pressure in the fuel tank and an atmospheric pressure, that is, when a large amount of evaporated fuel is pushed out from the fuel tank, the allowable number of times is reduced by a larger amount. Therefore, the amount of evaporated fuel adsorbed by the canister is able to be further accurately reflected in the allowable number of times.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing the schematic configuration of a vehicle;

FIG. 2 is a diagram showing the configuration of an internal combustion engine and the like; and

FIG. 3 is a flowchart showing leakage diagnosis control.

### DETAILED DESCRIPTION OF EMBODIMENTS

### Schematic Configuration of Vehicle

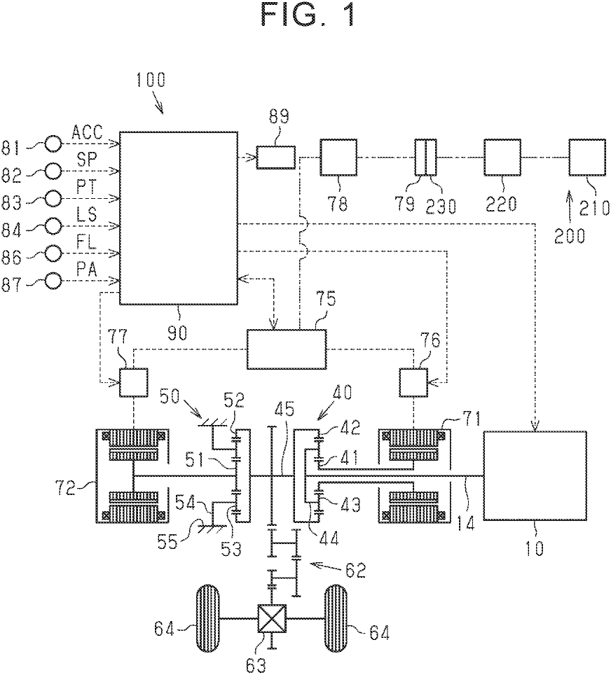

Hereinafter, an embodiment of the disclosure will be described with reference to FIG. 1 to FIG. 3. First, the schematic configuration of a vehicle 100 will be described.

As shown in FIG. 1, the vehicle 100 includes a spark-ignition internal combustion engine 10. The vehicle 100 further includes a first motor generator 71 and a second motor generator 72 each of which has the function of both an electric motor and a generator. Therefore, the vehicle 100 is a so-called hybrid electric vehicle. In the present embodiment, each of the internal combustion engine 10, the first motor generator 71, and the second motor generator 72 is a driving source of the vehicle 100.

The vehicle 100 includes a first planetary gear train 40, a ring gear shaft 45, a second planetary gear train 50, a speed reduction mechanism 62, a differential mechanism 63, and a plurality of drive wheels 64. The first planetary gear train 40 includes a sun gear 41, a ring gear 42, a plurality of pinion gears 43, and a carrier 44. The sun gear 41 is an external gear. The sun gear 41 is connected to the first motor generator 71. The ring gear 42 is an internal gear and is located coaxially with the sun gear 41. Each of the pinion gears 43 is located between the sun gear 41 and the ring gear 42. Each of the pinion gears 43 is in mesh with both the sun gear 41 and the ring gear 42. The carrier 44 supports the pinion gears 43. The pinion gears 43 each are rotatable on its axis and revolvable by rotating together with the carrier 44. The carrier 44 is connected to a crankshaft 14 of the internal combustion engine 10. Therefore, the first motor generator 71 is coupled to the crankshaft 14 of the internal combustion engine 10 via the first planetary gear train 40.

When the driving force of the internal combustion engine 10 is input to the carrier 44, the driving force of the internal combustion engine 10 is distributed between the sun gear 41 side and the ring gear 42 side. When the driving force of the internal combustion engine 10, transmitted via the sun gear 41, is input to the rotary shaft of the first motor generator 71, the first motor generator 71 functions as a generator.

On the other hand, when the first motor generator 71 is caused to function as an electric motor, the driving force of the first motor generator 71 is input to the sun gear 41. As a result, the driving force of the first motor generator 71, input to the sun gear 41, is distributed between the carrier 44 side and the ring gear 42 side. When the driving force of the first motor generator 71, transmitted via the carrier 44, is input to the crankshaft 14 of the internal combustion engine 10, the crankshaft 14 of the internal combustion engine 10 rotates.

The ring gear shaft 45 is connected to the ring gear 42. The ring gear shaft 45 is also connected to the drive wheels 64 via the speed reduction mechanism 62 and the differential mechanism 63. The speed reduction mechanism 62 reduces the rotation speed of the ring gear shaft 45 and outputs the rotation. The differential mechanism 63 allows a rotation speed difference between the right and left drive wheels 64.

The second planetary gear train 50 includes a sun gear 51, a ring gear 52, a plurality of pinion gears 53, a carrier 54, and a case 55. The sun gear 51 is an external gear. The sun gear 51 is connected to the second motor generator 72. The ring gear 52 is an internal gear and is located coaxially with the sun gear 51. The ring gear 52 is connected to the ring gear shaft 45. Each of the pinion gears 53 is located between the sun gear 51 and the ring gear 52. Each of the pinion gears 53 is in mesh with both the sun gear 51 and the ring gear 52. The carrier 54 supports the pinion gears 53. The pinion gears 53 each are rotatable on its axis. The carrier 54 is fixed to the case 55. Therefore, the pinion gears 53 are not revolvable.

The second motor generator 72 is capable of functioning as a generator at the time of decelerating the vehicle 100 to cause the vehicle 100 to generate regenerative braking force according to the amount of electric power generated by the second motor generator 72.

On the other hand, when the second motor generator 72 functions as an electric motor, the driving force of the second motor generator 72 is input to the drive wheels 64 via the second planetary gear train 50, the ring gear shaft 45, the speed reduction mechanism 62, and the differential mechanism 63. As a result, the drive wheels 64 rotate by using the driving force of the second motor generator 72.

The vehicle 100 includes a battery 75, a first inverter 76, and a second inverter 77. The first inverter 76 performs alternating-current and direct-current power conversion between the first motor generator 71 and the battery 75. The first inverter 76 adjusts the amount of electric power exchanged between the first motor generator 71 and the battery 75. The second inverter 77 performs alternating-current and direct-current power conversion between the second motor generator 72 and the battery 75. The second inverter 77 adjusts the amount of electric power exchanged between the second motor generator 72 and the battery 75.

The vehicle 100 includes a converter 78 and an inlet 79. The inlet 79 is able to connect with an external power supply 200 (described later). In other words, the vehicle 100 is a so-called plug-in hybrid electric vehicle. The inlet 79 is electrically connected to the battery 75 via the converter 78. Alternating-current power is supplied from the external power supply 200 to the inlet 79. The converter 78 converts alternating-current power, supplied from the inlet 79, to direct-current power. The converter 78 supplies the converted direct-current power to the battery 75. As a result, the battery 75 is charged from the external power supply 200. In other words, the battery 75 is chargeable from the external power supply 200 provided outside the vehicle 100.

### Configuration of Internal Combustion Engine

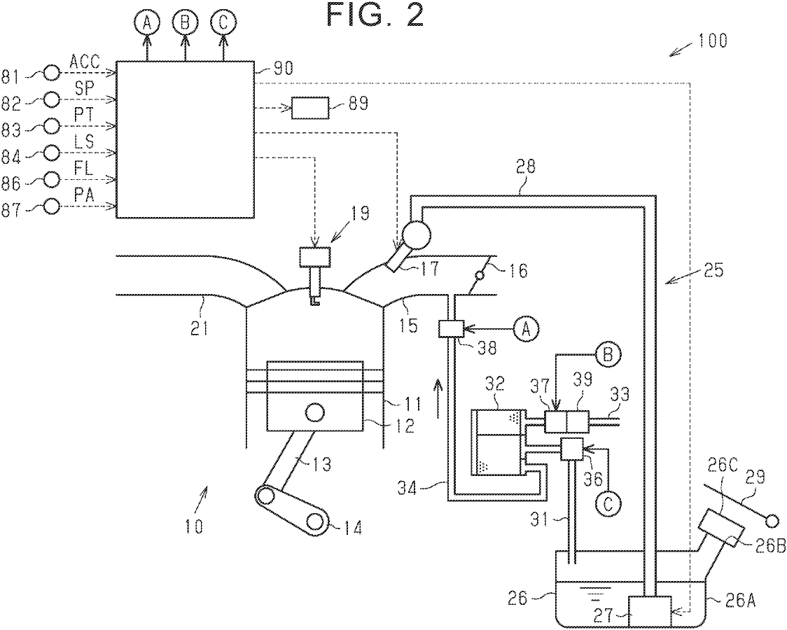

As shown in FIG. 2, the internal combustion engine 10 includes a plurality of cylinders 11, an intake passage 15, and an exhaust passage 21. Each of the cylinders 11 is a space in which air-fuel mixture of fuel and intake air combusts. The internal combustion engine 10 includes four cylinders 11. FIG. 2 shows only one cylinder 11. The intake passage 15 is connected to the cylinders 11. The intake passage 15 introduces intake air from outside the internal combustion engine 10 into the cylinders 11. The exhaust passage 21 is connected to the cylinders 11. The exhaust passage 21 emits exhaust gas from the cylinders 11 to outside the internal combustion engine 10.

The internal combustion engine 10 includes a plurality of pistons 12, a plurality of connecting rods 13, the crankshaft 14, a throttle valve 16, a plurality of fuel injection valves 17, and a plurality of ignition devices 19. The throttle valve 16 is located in the middle of the intake passage 15. The throttle valve 16 adjusts the amount of intake air flowing through the intake passage 15. Each of the fuel injection valves 17 is located near an associated one of the cylinders 11 in the intake passage 15. The internal combustion engine 10 includes four fuel injection valves 17, one for each of the four cylinders 11. Each of the fuel injection valves 17 injects fuel toward an associated one of the cylinders 11. Each of the ignition devices 19 is located near an associated one of the cylinders 11. The internal combustion engine 10 includes four ignition devices 19, one for each of the four cylinders 11. The ignition devices 19 ignite air-fuel mixture of fuel and intake air by using spark discharge.

Each of the pistons 12 is located in an associated one of the cylinders 11. The internal combustion engine 10 includes four pistons 12, one for each of the four cylinders 11. Each of the pistons 12 is coupled to the crankshaft 14 via an associated one of the connecting rods 13. Each of the pistons 12 reciprocates as a result of combustion of air-fuel mixture of fuel and intake air in an associated one of the cylinders 11. As a result of reciprocation of the pistons 12, the crankshaft 14 rotates.

### Configuration of Fuel Supply System

The vehicle 100 further includes a fuel supply system 25. The fuel supply system 25 includes a fuel tank 26, a feed pump 27, a fuel passage 28, and a lid door 29. The fuel tank 26 includes a tank body 26A and a cap 26C. The tank body 26A is able to store fuel. The tank body 26A includes a fill opening 26B for feeding fuel to the tank body 26A. The cap 26C closes the fill opening 26B of the tank body 26A. The cap 26C is detachable from the tank body 26A. The feed pump 27 is located in the tank body 26A of the fuel tank 26. The feed pump 27 connects with the fuel injection valves 17 via the fuel passage 28. Therefore, the feed pump 27 supplies fuel to the fuel injection valves 17 via the fuel passage 28. The lid door 29 makes up part of the exterior of the vehicle 100. The lid door 29 is located near the cap 26C. The lid door 29 is able to be opened and closed by operation of a driver or the like. In a state where the lid door 29 is closed, the lid door 29 covers the cap 26C.

The fuel supply system 25 includes a vapor passage 31, a canister 32, an outside air passage 33, a purge passage 34, a shut-off valve 36, an outside air valve 37, a purge valve 38, and a pump module 39. The canister 32 is able to adsorb evaporated fuel generated in the fuel tank 26. A first end of the vapor passage 31 is connected to the canister 32. A second end of the vapor passage 31 is located in the fuel tank 26. The shut-off valve 36 is located in the middle of the vapor passage 31. The shut-off valve 36 switches the flow channel of the vapor passage 31 to any one of an open state and a closed state. The shut-off valve 36 is a normally-closed electromagnetic valve.

A first end of the outside air passage 33 is connected to the canister 32. A second end of the outside air passage 33 is open to outside the vehicle 100. The outside air valve 37 is located in the middle of the outside air passage 33. The outside air valve 37 switches the flow channel of the outside air passage 33 to any one of an open state and a closed state. The outside air valve 37 is a normally-open electromagnetic valve. The pump module 39 is located in the middle of the outside air passage 33. The pump module 39 is connected to the outside air valve 37. The pump module 39 is able to emit gas from the fuel tank 26 to the outside via the vapor passage 31, the canister 32, and the outside air passage 33.

A first end of the purge passage 34 is connected to the canister 32. A second end of the purge passage 34 is connected to a downstream-side part of the intake passage 15 when viewed from the throttle valve 16. The purge valve 38 is located in the middle of the purge passage 34. The purge valve 38 is able to adjust the opening degree of the flow channel of the purge passage 34. The purge valve 38 is a normally-closed electromagnetic valve.

### Configuration of Sensor and Controller

As shown in FIG. 2, the vehicle 100 includes an accelerator operation amount sensor 81, a vehicle speed sensor 82, a pressure sensor 83, a lid sensor 84, a fuel level sensor 86, an atmospheric pressure sensor 87, and a display 89. The accelerator operation amount sensor 81 detects an accelerator operation amount ACC that is the operation amount of an accelerator pedal operated by the driver. The vehicle speed sensor 82 detects a vehicle speed SP that is the speed of the vehicle 100. The pressure sensor 83 is attached to the top part of the fuel tank 26. The pressure sensor 83 detects a tank internal pressure PT that is a pressure in the fuel tank 26. The lid sensor 84 detects an open-close position LS that is the position of the lid door 29. The fuel level sensor 86 is located in the fuel tank 26. The fuel level sensor 86 detects a fuel level FL that is the level of fuel in the fuel tank 26. The atmospheric pressure sensor 87 detects an atmospheric pressure PA that is the pressure of the atmosphere at a point where the vehicle 100 is located. The display 89 is located near the driver seat of the vehicle 100. The display 89 displays visual information to the driver or the like of the vehicle 100.

The vehicle 100 includes a controller 90. The controller 90 acquires a signal indicating an accelerator operation amount ACC from the accelerator operation amount sensor 81. The controller 90 acquires a signal indicating a vehicle speed SP from the vehicle speed sensor 82. The controller 90 acquires a signal indicating a tank internal pressure PT from the pressure sensor 83. The controller 90 acquires a signal indicating an open-close position LS from the lid sensor 84. The controller 90 acquires a signal indicating a fuel level FL from the fuel level sensor 86. In other words, the controller 90 is able to detect the amount of fuel in the fuel tank 26 and the amount of fuel fed to the fuel tank 26 based on the fuel level FL. The controller 90 acquires a signal indicating an atmospheric pressure PA from the atmospheric pressure sensor 87. The controller 90 causes the display 89 to display visual information by outputting a control signal to the display 89.

The controller 90 calculates a vehicle required driving force based on an accelerator operation amount ACC and a vehicle speed SP. A vehicle required driving force is a required value of driving force needed for the vehicle 100 to run. The controller 90 determines a torque distribution among the internal combustion engine 10, the first motor generator 71, and the second motor generator 72 based on the vehicle required driving force. The controller 90 controls the output of the internal combustion engine 10 and the motoring and regeneration of each of the first motor generator 71 and the second motor generator 72 based on the torque distribution among the internal combustion engine 10, the first motor generator 71, and the second motor generator 72. Specifically, the controller 90 controls the opening degree of the throttle valve 16, a fuel injection amount from each of the fuel injection valves 17, the ignition timing of each of the ignition devices 19, and the like by outputting a control signal to the internal combustion engine 10. The controller 90 controls the first motor generator 71 via the first inverter 76 by outputting a control signal to the first inverter 76. The controller 90 controls the second motor generator 72 via the second inverter 77 by outputting a control signal to the second inverter 77.

The controller 90 executes introduction control to introduce evaporated fuel adsorbed by the canister 32 into the intake passage 15 while the internal combustion engine 10 is being driven. Specifically, the controller 90 opens the shut-off valve 36, the outside air valve 37, and the purge valve 38 while the internal combustion engine 10 is being driven. Then, outside air is introduced into the canister 32 via the outside air passage 33 due to negative pressure in the intake passage 15. As a result, evaporated fuel adsorbed by the canister 32 and outside air are introduced into the intake passage 15 via the purge passage 34.

The controller 90 executes preparation control to prepare for feeding fuel at the time of feeding fuel to the fuel tank 26. Specifically, the controller 90 detects the status of the lid door 29 based on the open-close position LS. When the controller 90 detects that the lid door 29 is in an open state, the controller 90 closes the purge valve 38 and opens the shut-off valve 36 and the outside air valve 37. Then, at the time of feeding fuel to the fuel tank 26, gas in the fuel tank 26 is able to move from the fuel tank 26 to the canister 32. As a result, at the time of feeding fuel to the fuel tank 26, emission of gas from the fuel tank 26 via the fill opening 26B of the fuel tank 26 to the outside is suppressed.

The controller 90 can be configured as circuitry including one or more processors that execute various processes in accordance with a computer program (software). The controller 90 may be configured as one or more dedicated hardware circuits, such as application-specific integrated circuits (ASICs), that execute at least part of the various processes, or circuitry including a combination of them. Each processor includes a CPU, and a memory, such as a RAM and a ROM. The memory stores program codes or instructions configured to cause the CPU to execute processes. The memory, that is, a computer-readable medium, includes any medium accessible by a general-purpose or special-purpose computer.

### External Power Supply

As shown in FIG. 1, the external power supply 200 includes a power supply body 210, a breaker 220, and a connector 230. The connector 230 is able to connect with the inlet 79. The connector 230 is connected to the power supply body 210 via the breaker 220. The breaker 220 is able to break electrical connection between the connector 230 and the power supply body 210. The power supply body 210 is able to supply alternating-current power.

### Leakage Diagnosis Control

Next, leakage diagnosis control that is executed by the controller 90 will be described. When the internal combustion engine 10 stops, the controller 90 executes leakage diagnosis control over the fuel tank 26. In the present embodiment, the controller 90 is an example of a leakage diagnostic device. Hereinafter, a period from when the internal combustion engine 10 stops to when the internal combustion engine 10 restarts is referred to as a stop period of the internal combustion engine 10.

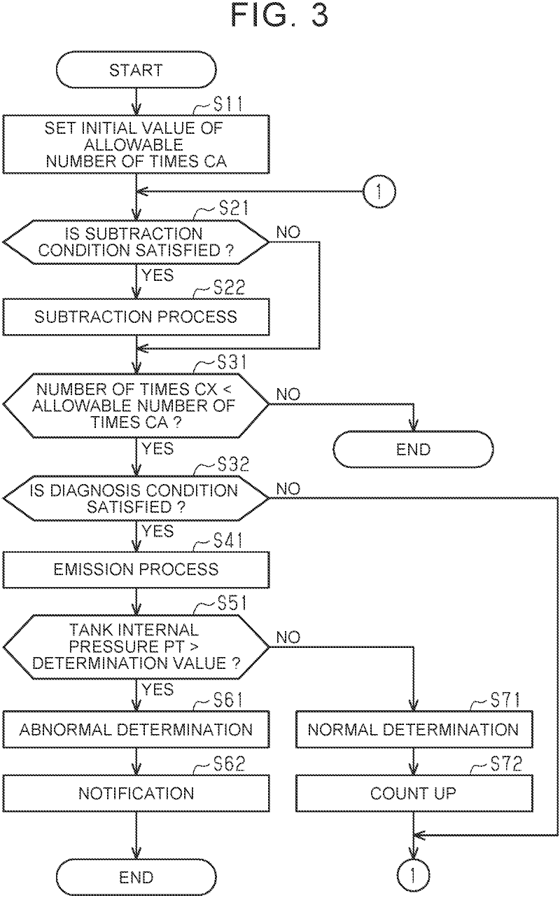

As shown in FIG. 3, when the controller 90 starts leakage diagnosis control, the controller 90 proceeds with the process to step S11. In step S11, the controller 90 sets an initial value of an allowable number of times CA. The initial value of the allowable number of times CA is a predetermined value. An example of the initial value of the allowable number of times CA is 10. Here, the allowable number of times CA is a value for limiting execution of leakage diagnosis in the current stop period. After that, the controller 90 proceeds with the process to step S21.

In step S21, the controller 90 determines whether a predetermined subtraction condition is satisfied. The subtraction condition is satisfied when at least one of the following condition (A) and condition (B) is satisfied.

Condition (A): Fuel has been fed to the fuel tank 26 in a current stop period. Condition (B): In a current stop period, there is a period during which the tank internal pressure PT is higher than the atmospheric pressure PA and the shut-off valve 36 is open.

In determining whether Condition (A) is satisfied, the controller 90 detects the amount of fuel in the fuel tank 26 based on the fuel level FL. When the amount of fuel in the fuel tank 26 is increased during the current stop period, the controller 90 determines that fuel has been fed to the fuel tank 26.

In step S21, when the controller 90 determines that the subtraction condition is not satisfied (NO in S21), the controller 90 proceeds with the process to step S31. On the other hand, in step S21, when the controller 90 determines that the subtraction condition is satisfied (YES in S21), the controller 90 proceeds with the process to step S22.

In step S22, the controller 90 executes the subtraction process to subtract the allowable number of times CA in the current stop period. Specifically, when the controller 90 determines that Condition (A) is satisfied in the process of the last step S21, the controller 90 reduces the allowable number of times CA as follows. The controller 90 increases the amount of subtraction of the allowable number of times CA when a large amount of fuel has been fed to the fuel tank 26 in the current stop period as compared to when a small amount of fuel has been fed to the fuel tank 26 in the current stop period. The amount of subtraction is increased in a stepwise manner as the amount of fuel fed increases. For example, the amount of subtraction is set to one when the amount of fuel fed is less than 10 liters, and the amount of subtraction is set to two when the amount of fuel fed is greater than or equal to 10 liters and less than 20 liters. When the controller 90 determines that Condition (B) is satisfied in the process of the last step S21, the controller 90 reduces the allowable number of times CA as follows. The controller 90 increases the amount of subtraction of the allowable number of times CA when there is a large difference between the tank internal pressure PT and the atmospheric pressure PA at the time of the process of step S22 as compared to when there is a small difference between the tank internal pressure PT and the atmospheric pressure PA at the time of the process of step S22. In this case as well, as in the case of the amount of fuel fed, the amount of subtraction is increased by one each time the difference between the tank internal pressure PT and the atmospheric pressure PA becomes larger than a set value. In this way, the controller 90 obtains a new allowable number of times CA by performing reduction based on the amount of fuel fed and the tank internal pressure PT from the allowable number of times CA at the beginning of step S22. After that, the controller 90 proceeds with the process to step S31.

In step S31, the controller 90 determines whether the number of times CX a leakage diagnosis of the fuel tank 26 is performed in the current stop period is less than the predetermined allowable number of times CA. Here, performing a leakage diagnosis is to execute the process from step S41 (described later). At the beginning of the current stop period, that is, at the time when the internal combustion engine 10 stops, the number of times CX is zero. In step S31, when the controller 90 determines that the number of times CX in the current stop period is greater than or equal to the allowable number of times CA (NO in S31), the controller 90 ends the current leakage diagnosis control. On the other hand, in step S31, when the controller 90 determines that the number of times CX in the current stop period is less than the allowable number of times CA (YES in S31), the controller 90 proceeds with the process to step S32.

In step S32, the controller 90 determines whether the predetermined diagnosis condition is satisfied. For example, the case where the diagnosis condition is satisfied is a case where any one of the following Condition (C) and Condition (D) is satisfied.

Condition (C): The process of step S41 (described later) is not executed in the current stop period, and the length of the current stop period is longer than or equal to a predetermined prescribed period.

Condition (D): An elapsed time from the last execution of the process of step S41 (described later) to the time of the process of step S32 in the current stop period is longer than or equal to a predetermined prescribed period.

Here, an example of the prescribed period is several tens of minutes to several hours. In step S32, when the controller 90 determines that the diagnosis condition is not satisfied (NO in S32), the controller 90 proceeds with the process to step S21 again. On the other hand, in step S32, when the controller 90 determines that the diagnosis condition is satisfied (YES in S32), the controller 90 proceeds with the process to step S41.

In step S41, the controller 90 executes the emission process of emitting gas from the fuel tank 26. Specifically, the controller 90 closes the purge valve 38 and opens the shut-off valve 36 and the outside air valve 37. The controller 90 emits gas from the fuel tank 26 to the outside via the vapor passage 31, the canister 32, and the outside air passage 33 by using the pump module 39. At this time, evaporated fuel contained in gas in the fuel tank 26 is adsorbed by the canister 32, so emission of gas containing evaporated fuel to the outside is suppressed. After that, the controller 90 proceeds with the process to step S51.

In step S51, the controller 90 determines whether the tank internal pressure PT is higher than a predetermined determination value. Here, the determination value is determined as follows. Initially, when there is no abnormality in the fuel tank 26, the emission process of step S41 is executed, with the result that the tank internal pressure PT becomes lower than or equal to a set value. On the other hand, when there occurs an abnormality, such as a crack, in the fuel tank 26, even when the emission process of step S41 is executed, the tank internal pressure PT does not become lower than or equal to the set value because gas enters from outside the fuel tank 26. Therefore, the set value is obtained by an experiment or the like. Then, the set value is determined as a determination value. In step S51, when the controller 90 determines that the tank internal pressure PT is higher than the determination value (YES in S51), the controller 90 proceeds with the process to step S61.

In step S61, the controller 90 determines that the fuel tank 26 is abnormal. After that, the controller 90 proceeds with the process to step S62. In step S62, the controller 90 notifies the driver or the like via the display 89 that the fuel tank 26 is abnormal by outputting a control signal to the display 89. After that, the controller 90 ends leakage diagnosis control.

On the other hand, in step S51, when the controller 90 determines that the tank internal pressure PT is lower than or equal to the determination value (NO in S51), the controller 90 proceeds with the process to step S71. In step S71, the controller 90 determines that the fuel tank 26 is normal. After that, the controller 90 proceeds with the process to step S72. In step S72, the controller 90 counts up the number of times CX by one. After that, the controller 90 proceeds with the process to step S21 again. In the present embodiment, the process of step S51, step S71, and step S72 is an example of the diagnosis process of performing a leakage diagnosis. The tank internal pressure PT detected by the pressure sensor 83 is an example of an index value indicating the pressure in the fuel tank 26.

### Operation of Present Embodiment

In the vehicle 100, when a leakage diagnosis is performed in a stop period of the internal combustion engine 10, gas is emitted from the fuel tank 26 to the outside via the vapor passage 31, the canister 32, and the outside air passage 33. At this time, evaporated fuel contained in gas in the fuel tank 26 is adsorbed by the canister 32. Therefore, each time a leakage diagnosis is performed, the amount of evaporated fuel adsorbed by the canister 32 increases.

When fuel is fed to the fuel tank 26 in the stop period of the internal combustion engine 10, preparation control is executed. In the preparation control, the purge valve 38 is closed, and the shut-off valve 36 and the outside air valve 37 are opened. Then, as a result of feeding fuel to the fuel tank 26 from the fill opening 26B, gas in the fuel tank 26 is pushed out to the vapor passage 31. When gas in the fuel tank 26 moves to the canister 32, evaporated fuel contained in gas is adsorbed by the canister 32. As a result, even when a leakage diagnosis is not performed in the stop period of the internal combustion engine 10, the amount of evaporated fuel adsorbed by the canister 32 increases.

### Advantageous Effects of Present Embodiment

(1) In the vehicle 100, when fuel has been fed to the fuel tank 26 in a stop period of the internal combustion engine 10, the subtraction process of reducing the allowable number of times CA is executed. In other words, when the amount of evaporated fuel adsorbed by the canister 32 increases as a result of feeding fuel to the fuel tank 26, the subtraction process of reducing the allowable number of times CA is executed. Therefore, after fuel is fed to the fuel tank 26, the number of times CX a leakage diagnosis is performed is further strictly limited. Thus, an excessively large amount of evaporated fuel adsorbed by the canister 32 is suppressed. As a result, this reduces a situation in which a leakage diagnosis is performed regardless of the fact that the amount of evaporated fuel that is able to be adsorbed by the canister 32 is small and, as a result, gas containing evaporated fuel is emitted to the outside.

(2) In the vehicle 100, the amount of subtraction of the allowable number of times CA increases when a large amount of fuel has been fed to the fuel tank 26 as compared to when a small amount of fuel has been fed to the fuel tank 26. In other words, as the amount of evaporated fuel pushed out from the fuel tank 26 increases due to the fact that the amount of fuel fed to the fuel tank 26 increases, the amount of subtraction of the allowable number of times CA increases. Therefore, it is possible to adjust the allowable number of times CA by further accurately reflecting the amount of evaporated fuel adsorbed by the canister 32.

(3) In the vehicle 100, even when fuel is actually not fed to the fuel tank 26, the lid door 29 can be set to an open state due to, for example, erroneous operation of the driver or the like. In this case as well, the open state of the lid door 29 is detected based on the open-close position LS, so the purge valve 38 is closed, and the shut-off valve 36 and the outside air valve 37 are opened. At this time, if the tank internal pressure PT is higher than the atmospheric pressure PA, gas in the fuel tank 26 is pushed out to the vapor passage 31. When gas in the fuel tank 26 moves to the canister 32, evaporated fuel contained in gas is adsorbed by the canister 32. As a result, even when a leakage diagnosis is not performed in the stop period of the internal combustion engine 10, the amount of evaporated fuel adsorbed by the canister 32 increases.

In terms of this point, in the vehicle 100, when the tank internal pressure PT is higher than the atmospheric pressure PA and the shut-off valve 36 is opened in a stop period of the internal combustion engine 10, the subtraction process of reducing the allowable number of times CA is executed. In other words, when the amount of evaporated fuel adsorbed by the canister 32 increases as a result of high pressure in the fuel tank 26, the subtraction process of reducing the allowable number of times CA is executed. Therefore, the number of times CX a leakage diagnosis is performed is further strictly limited. Thus, an excessively large amount of evaporated fuel adsorbed by the canister 32 is suppressed. As a result, this reduces a situation in which a leakage diagnosis is performed regardless of the fact that the amount of evaporated fuel that is able to be adsorbed by the canister 32 is small and, as a result, gas containing evaporated fuel is emitted to the outside.

(4) In the vehicle 100, when there is a large difference between the tank internal pressure PT and the atmospheric pressure PA, the amount of subtraction of the allowable number of times CA increases as compared to when there is a small difference between the tank internal pressure PT and the atmospheric pressure PA. In other words, as the amount of evaporated fuel pushed out from the fuel tank 26 increases due to a large difference between the tank internal pressure PT and the atmospheric pressure PA, the amount of subtraction of the allowable number of times CA increases. Therefore, it is possible to adjust the allowable number of times CA by further accurately reflecting the amount of evaporated fuel adsorbed by the canister 32.

(5) In the above vehicle 100, the vehicle 100 can be driven by using the driving force of only the second motor generator 72, so there are many opportunities to stop the internal combustion engine 10. As the opportunity to stop the internal combustion engine 10 increases, an opportunity to perform a leakage diagnosis increases. In the vehicle 100, fuel can be fed while the internal combustion engine 10 is stopped as described above. In this way, it is suitable to apply the controller 90 that performs the leakage diagnosis to the vehicle 100 in which there are many opportunities to perform a leakage diagnosis and there are many opportunities to feed fuel during a stop of the internal combustion engine 10.

(6) The battery 75 of the vehicle 100 is chargeable from the external power supply 200. In the vehicle 100, the battery 75 generally has a large capacity, so one stop period of the internal combustion engine 10 tends to be long. As a result, the number of times CX a leakage diagnosis is performed in one stop period of the internal combustion engine 10 tends to increase. Therefore, it is suitable to apply the controller 90 that performs the leakage diagnosis to the vehicle 100.

### Modifications

The present embodiment may be modified as follows. The present embodiment and the following modifications may be implemented in combination with each other without any technical contradiction.

In leakage diagnosis control of the above embodiment, a manner of setting the initial value of the allowable number of times CA in step S11 may be changed. As a specific example, the amount of evaporated fuel adsorbed by the canister 32 at the beginning of the current stop period varies depending on the drive status of the internal combustion engine 10 just before the current stop period. For this reason, the controller 90 may change a value to be set as the initial value of the allowable number of times CA depending on the drive status of the internal combustion engine 10 just before the current stop period. In this way, even when the allowable number of times CA is variable according to the drive status of the internal combustion engine 10, but when the controller 90 calculates the allowable number of times CA by using a prestored map, an arithmetic expression, or the like, the allowable number of times CA is a predetermined value.

In leakage diagnosis control of the above embodiment, the subtraction condition in step S21 may be changed. Specifically, two conditions, that is, Condition (A) and Condition (B), do not need to be adopted, and only one of Condition (A) and Condition (B) may be adopted.

In leakage diagnosis control of the above embodiment, a manner of the subtraction process in step S22 may be changed. As a specific example, when the controller 90 determines in the process of the last step S21 that Condition (A) is satisfied, the allowable number of times CA may be reduced by a predetermined fixed number of times regardless of the amount of fuel fed to the fuel tank 26 in the current stop period. When the controller 90 determines in the process of the last step S21 that Condition (B) is satisfied, the allowable number of times CA may be reduced by a predetermined fixed number of times regardless of a difference between the tank internal pressure PT and the atmospheric pressure PA at the time of the process of step S22.

In leakage diagnosis control of the above embodiment, the index value indicating the pressure in the fuel tank 26 in step S51 may be changed. As a specific example, the pump module 39 can include a pressure sensor. In this case, a pressure detected by the pressure sensor of the pump module 39 may be used as the index value indicating the pressure in the fuel tank 26.

In the above embodiment, the vehicle 100 does not need to be a plug-in hybrid electric vehicle. For example, the battery 75 does not need to be chargeable from the external power supply 200 provided outside the vehicle 100. In this case, the converter 78 and the inlet 79 may be omitted. For example, the vehicle 100 does not need to include the first motor generator 71 and the second motor generator 72. In other words, as long as the vehicle 100 includes the internal combustion engine 10 and the leakage diagnostic device that performs a diagnosis of the fuel supply system 25 that supplies fuel to the internal combustion engine 10, the technology can be applied.

What is claimed is:

1. A leakage diagnostic device comprising circuitry configured to perform a diagnosis of a fuel supply system, wherein:
the fuel supply system includes
a fuel tank configured to store fuel,
a vapor passage connected to the fuel tank,
a canister connected to the vapor passage and configured to be able to adsorb evaporated fuel generated in the fuel tank,
an outside air passage connected to the canister, and
a shut-off valve configured to open and close a flow channel of the vapor passage; and
the circuitry is configured to execute
an emission process of, on condition that the number of times a leakage diagnosis of the fuel tank is performed in a stop period from when an internal combustion engine stops to when the internal combustion engine restarts is less than a predetermined allowable number of times, emitting gas from the fuel tank via the canister by opening the shut-off valve,
a diagnosis process of performing the leakage diagnosis based on a change in index value, caused by the emission process, the index value indicating a pressure in the fuel tank, and
a subtraction process of, when fuel has been fed to the fuel tank in a state where the shut-off valve is open in the stop period of the internal combustion engine, reducing the allowable number of times in the stop period in which fuel has been fed to the fuel tank.

2. The leakage diagnostic device according to claim 1, wherein, in the subtraction process, the circuitry is configured to increase an amount of subtraction of the allowable number of times when a large amount of fuel is fed to the fuel tank in the stop period as compared to the amount of subtraction of the allowable number of times when a small amount of fuel is fed to the fuel tank in the stop period.

3. A vehicle comprising:
an internal combustion engine serving as a driving source of the vehicle;
a motor generator serving as a driving source of the vehicle;
a battery configured to supply electric power to the motor generator;
a fuel supply system configured to supply fuel to the internal combustion engine; and
a leakage diagnostic device configured to perform a diagnosis of the fuel supply system, wherein:
the fuel supply system includes
a fuel tank configured to store fuel,
a vapor passage connected to the fuel tank,
a canister connected to the vapor passage and configured to be able to adsorb evaporated fuel generated in the fuel tank,
an outside air passage connected to the canister, and
a shut-off valve configured to open and close a flow channel of the vapor passage; and
the leakage diagnostic device is configured to execute
an emission process of, on condition that the number of times a leakage diagnosis of the fuel tank is performed in a stop period from when the internal combustion engine stops to when the internal combustion engine restarts is less than a predetermined allowable number of times, emitting gas from the fuel tank via the canister by opening the shut-off valve,
a diagnosis process of performing the leakage diagnosis based on a change in index value, caused by the emission process, the index value indicating a pressure in the fuel tank, and
a subtraction process of, when fuel has been fed to the fuel tank in a state where the shut-off valve is open in the stop period of the internal combustion engine, reducing the allowable number of times in the stop period in which fuel has been fed to the fuel tank.

4. The vehicle according to claim 3, wherein the battery is chargeable from an external power supply provided outside the vehicle.

5. A leakage diagnostic device comprising circuitry configured to perform a diagnosis of a fuel supply system, wherein:
the fuel supply system includes
a fuel tank configured to store fuel,
a vapor passage connected to the fuel tank,
a canister connected to the vapor passage and configured to be able to adsorb evaporated fuel generated in the fuel tank,
an outside air passage connected to the canister, and
a shut-off valve configured to open and close a flow channel of the vapor passage; and
the circuitry is configured to execute
an emission process of, on condition that the number of times a leakage diagnosis of the fuel tank is performed in a stop period from when an internal combustion engine stops to when the internal combustion engine restarts is less than a predetermined allowable number of times, emitting gas from the fuel tank via the canister by opening the shut-off valve,
a diagnosis process of performing the leakage diagnosis based on a change in index value, caused by the emission process, the index value indicating a pressure in the fuel tank, and
a subtraction process of, when the pressure in the fuel tank is higher than an atmospheric pressure and the shut-off valve is opened in the stop period of the internal combustion engine, reducing the allowable number of times in the stop period while the shut-off valve is open.

6. The leakage diagnostic device according to claim 5, wherein, in the subtraction process, the circuitry is configured to increase an amount of subtraction of the allowable number of times when there is a large difference between the pressure in the fuel tank and the atmospheric pressure in the stop period as compared to an amount of subtraction of the allowable number of times when there is a small difference between the pressure in the fuel tank and the atmospheric pressure in the stop period.
